(19) United States
(12) Patent Application Publication
(10) Pub. No.: US 2026/0097486 A1
(43) Pub. Date: Apr. 9, 2026

(54) TECHNIQUES FOR TRAINING ROBOTS FOR DEXTEROUS MANIPULATION TASKS

(71) Applicant: Massachusetts Institute of Technology, Cambridge, MA (US)

(72) Inventors: Haoshu Fang, Cambridge, MA (US); Arthur Hu, Cambridge, MA (US); Branden Romero, Brighton, MA (US); Edward Adelson, Winchester, MA (US); Pulkit Agrawal, Cambridge, MA (US)

(73) Assignee: Massachusetts Institute of Technology, Cambridge, MA (US)

(21) Appl. No.: 19/348,334

(22) Filed: Oct. 2, 2025

Related U.S. Application Data
(60) Provisional application No. 63/703,866, filed on Oct. 4, 2024.

(51) Int. Cl. B25J 9/00; B25J 9/16; B25J 13/08; B25J 19/02

(52) U.S. Cl. CPC B25J 9/0081; B25J 9/0006; B25J 9/1612; B25J 13/082; B25J 13/088; B25J 19/021

(57) ABSTRACT

The techniques described herein relate to systems, apparatus, articles of manufacture, and methods for training robots for dexterous manipulation tasks. An example apparatus for training a robotic system includes an end effector configured to manipulate an object, a passive exoskeleton configured to be manipulated by a portion of a user's body to change one or more parameters of the end effector, one or more linkages coupling the end effector to the passive exoskeleton, wherein the one or more linkages transmit forces applied to the end effector, due to interactions of the end effector with a surrounding environment comprising the object, to the portion of the user's body through the passive exoskeleton, and one or more sensors coupled to the end effector and configured to sense the one or more parameters of the end effector, and output one or more signals indicative of the one or more parameters.

### RELATED APPLICATION

This application claims priority under 35 U.S.C. § 119(e) to U.S. Provisional Application No. 63/703,866, filed Oct. 4, 2024, the content of which is incorporated by reference in its entirety for all purposes.

### GOVERNMENT SUPPORT

This invention was made with government support under N00014-18-1-2815 awarded by the Office of Naval Research. The government has certain rights in this invention.

### FIELD

The techniques described herein relate generally to robots and, more particularly, to techniques for training robots for dexterous manipulation tasks.

### BACKGROUND

Dexterous manipulation is a challenging task in robotics. While advances in robotic learning systems have improved certain aspects of manipulation, teaching robots to perform dexterous tasks still presents significant challenges. Current methods, including reinforcement learning, learning from videos, and teleoperation, each face distinct limitations that reduce their effectiveness in real-world applications.

### SUMMARY

In accordance with the disclosed subject matter, techniques are provided for training robots for dexterous manipulation tasks.

Some embodiments relate to an apparatus for training a robotic system. The apparatus comprises an end effector configured to manipulate an object, a passive exoskeleton configured to be manipulated by a portion of a user's body to change one or more parameters of the end effector, one or more linkages coupling the end effector to the passive exoskeleton, wherein the one or more linkages transmit forces applied to the end effector, due to interactions of the end effector with a surrounding environment comprising the object, to the portion of the user's body through the passive exoskeleton, and one or more sensors coupled to the end effector and configured to sense the one or more parameters of the end effector; and output one or more signals indicative of the one or more parameters.

Some embodiments relate to a method for training a robotic system. The method comprises manually manipulating, using a passive exoskeleton, one or more parameters of an end effector to manipulate an object, transmitting, using one or more linkages of the passive exoskeleton, forces applied to the end effector to a portion of a user's body due to interactions of the end effector with a surrounding environment, and sensing, using one or more sensors, one or more parameters of the end effector while facilitating manipulation of the object to generate a training dataset for operation of the robotic system.

Some embodiments relate to at least one computer-readable storage medium storing processor executable instructions that, when executed by at least one hardware processor, cause the at least one hardware processor to receive, using at least one communication interface, sensor data from one or more sensors configured to sense one or more parameters of an end effector when the end effector is manually manipulated by a passive exoskeleton to manipulate an object, generate, using the sensor data, a training dataset for operation of a robotic system comprising the end effector, and cause a change in the one or more parameters of the end effector to manipulate the object in accordance with the training dataset.

The foregoing summary is not intended to be limiting. Moreover, various aspects of the present disclosure may be implemented alone or in combination with other aspects.

### BRIEF DESCRIPTION OF FIGURES

Various aspects and embodiments of the present technology will be described with reference to the following figures. It should be appreciated that the figures are not necessarily drawn to scale. Items appearing in multiple figures are indicated by the same or a similar reference number in all the figures in which they appear.

FIG. 1 shows an example end effector configured to be manually manipulated by a portion of a user's body using a passive exoskeleton, in accordance with some embodiments of the technology described herein.

FIG. 2 shows an exploded view of the end effector and the passive exoskeleton of FIG. 1, in accordance with some embodiments of the technology described herein.

FIG. 3A shows a passive portion of the end effector of FIGS. 1 and/or 2, in accordance with some embodiments of the technology described herein.

FIG. 3B shows an active portion of an end effector, in accordance with some embodiments of the technology described herein.

FIG. 4 shows example kinematic chains for the end effector of FIGS. 1 and/or 2, in accordance with some embodiments of the technology described herein.

FIG. 5 shows a side view of example linkage systems coupling an index finger of the end effector and the passive exoskeleton of FIGS. 1 and/or 2, in accordance with some embodiments of the technology described herein.

FIG. 6 shows a perspective view of example linkage systems coupling a thumb of the end effector and the passive exoskeleton of FIGS. 1 and/or 2, in accordance with some embodiments of the technology described herein.

FIG. 7 shows a block diagram of an example implementation of a training controller and a portion of the end effector of FIGS. 1 and/or 2, in accordance with some embodiments of the technology described herein.

FIG. 8 is a flowchart representative of an example process that may be performed and/or example machine-readable instructions that may be executed by processor circuitry to implement the training controller of FIG. 7 to cause a change in parameter(s) of the end effector of FIGS. 1 and/or 2 to manipulate an object in accordance with a training dataset, in accordance with some embodiments of the technology described herein.

FIG. 9 is an example electronic platform structured to execute the machine-readable instructions of FIG. 8 to implement the end effector of FIGS. 1 and/or 2 and/or the training controller of FIG. 7, in accordance with some embodiments of the technology described herein.

### DETAILED DESCRIPTION

The present disclosure generally provides techniques for training robots for dexterous manipulation tasks, allowing robots to replicate human-level skills by collecting large-scale data through user demonstrations. The techniques involve generating sensor data responsive to a user (e.g., a human user) manually manipulating an end effector (e.g., a robot hand) using a passive exoskeleton. The techniques involve generating a training dataset using the sensor data. The techniques involve operating the end effector in accordance with the training dataset to perform a dexterous manipulation task without the user's involvement. An example use case includes generating a training dataset to autonomously operate a robot hand to perform a dexterous manipulation task, such as drilling a hole using a power drill.

A dexterous manipulation task can be a task performed using at least one body part, such as at least one hand, to manipulate an object. Examples of dexterous manipulation tasks include drilling a hole using a power drill, installing a component such as a light bulb into a socket, opening or closing a box, and opening or closing a container (e.g., a bottle, a can, a vessel).

Dexterous manipulation remains one of the most challenging technological tasks in robotics. While there are current techniques that may be used in robotic learning systems, it has been recognized, within the context of the present disclosure, that they each face distinct limitations that reduce their effectiveness in real-world applications.

A first conventional technique is reinforcement learning. For example, a robotic system may be trained to perform a task using reinforcement learning. However, reinforcement learning requires careful reward engineering and setting up the simulated environments, working mainly for in-hand manipulation tasks.

A second conventional technique is learning from videos. However, it has been recognized, within the context of the present disclosure, that learning from videos is hindered by the morphology gap between human demonstrators and robotic agents. Furthermore, video demonstrations lack the detailed contact information necessary for teaching fine manipulation skills.

A third conventional technique is teleoperation. Teleoperation may use webcams, virtual reality (VR) devices, or haptic gloves as the input device for teleoperating manipulation tasks. However, it has been recognized, within the context of the present disclosure, that teleoperation faces issues of scalability and intuitiveness, particularly in dexterous hand manipulation. For example, most vision-based teleoperation techniques do not incorporate haptic feedback or use vibration feedback, which is unintuitive. Teleoperated systems lacking haptic feedback make it difficult for users of these systems to naturally control robots, especially in contact-rich tasks. Further, existing haptic feedback devices are expensive, and usually only provide force on fingertips. Although teleoperated demonstrations may have advantages compared to other techniques, the absence of intuitive control and haptic feedback limits their usefulness.

Some teleoperation techniques involve using hand exoskeletons. However, it has been recognized, within the context of the present disclosure, that their use focused on teleoperation settings, failing to address the scalability, intuitive control, and force transparency that is desirable for dexterous robotic manipulation in-the-wild. Additionally, such hand exoskeletons typically provide humans with external forces through actuators (e.g., electro-mechanical actuators).

One aspect of the disclosure relates to the development of a passive exoskeleton coupled to an end effector that, in accordance with certain embodiments, overcomes the aforementioned technological challenges. In some embodiments, the passive exoskeleton is a hand exoskeleton system configured for teaching robots dexterous manipulation tasks in-the-wild. In some such embodiments, the passive exoskeleton does not include any actuators and substantially matches the kinematics of the user's body. Unlike traditional teleoperation systems, which are limited by the lack of haptic feedback and scalability, the passive exoskeleton enables natural and intuitive control through kinematic mirroring and force transparency. For example, the passive exoskeleton can be configured to mirror human hand movements to enable direct control of an end effector (e.g., a hand) with precise kinematic mapping.

Beneficially, the system including the passive exoskeleton and the end effector offers advantages over conventional techniques by maintaining force transparency, allowing users to experience real-time haptic feedback through the end effector, thus addressing one of the limiting technological challenges in conventional teleoperation techniques. For example, the disclosed system overcomes the technology challenge with teleoperation by enabling haptic feedback and transmitting force feedback from the end effector (e.g., the hand) to the user's body (e.g., the user's fingers), enabling precise manipulation and grip control.

In some embodiments, the passive exoskeleton is equipped with integrated tactile sensors that capture high-fidelity interaction data and facilitate manipulation learning without the need for costly hardware or careful engineering as required by some conventional techniques, such as reinforcement learning. For example, the disclosed system can generate a training dataset using high-fidelity interaction data and facilitate manipulation learning without reward engineering and eliminates the need to set up a simulated environment.

The configuration of the passive exoskeleton allows users (e.g., human users) to directly control a robot's dexterous hand, transmitting precise motion and force data for learning complex tasks in real-world environments. Such precise motion and force data can be used to generate high-fidelity training datasets. These high-fidelity training datasets are not affected by the morphology gap and thereby have an advantage over training datasets that are generated during learning from videos techniques that are adversely affected because of the morphology gap. Additionally, the disclosed system can be implemented with substantially less cost with respect to conventional robot learning systems and are easier to setup, which allows for efficient, large-scale data collection across diverse manipulation tasks.

In some embodiments, the disclosed system is augmented with a variety of sensors that can be used to generate and/or provide a rich corpus of training data for a training dataset. The sensor data generated from the sensors can be used to determine one or more parameters of the end effector. Example sensors include encoders, inertial measurement units (IMUs), cameras, and tactile sensors. Example parameters of the end effector include an acceleration, a direction, a pose, or a speed of a portion (e.g., at least one robot finger, the robot hand) of the end effector.

In some embodiments, a training controller is configured to receive the parameters and generate a training dataset using the parameters. The training controller can generate machine readable instructions (e.g., software, firmware) that, when executed by at least one hardware processor of a robot including the end effector, can be autonomously operated to perform dexterous manipulation tasks in accordance with the training dataset.

Accordingly, some embodiments provide for an apparatus for training a robotic system comprising an end effector configured to manipulate an object, a passive exoskeleton configured to be manipulated by a portion of a user's body to change one or more parameters of the end effector, one or more linkages, and one or more sensors. In some embodiments, the one or more linkages couple the end effector to the passive exoskeleton, wherein the one or more linkages transmit forces applied to the end effector, due to interactions of the end effector with a surrounding environment comprising the object, to the portion of the user's body through the passive exoskeleton. In some embodiments, the one or more sensors are coupled to the end effector and are configured to sense the one or more parameters of the end effector and output one or more signals indicative of the one or more parameters.

In some embodiments, the apparatus further comprises one or more hardware processors configured to receive the one or more signals indicative of the one or more parameters, and generate a training dataset for operation of the robotic system using the one or more parameters of the end effector. In some such embodiments, the end effector comprises one or more actuators operatively coupled to the end effector and are configured to change the one or more parameters of the end effector in accordance with the training dataset.

In some embodiments, the end effector comprises a plurality of fingers configured to manipulate the object. In some embodiments, the one or more linkages are one or more rigid linkages. In some embodiments, the passive exoskeleton does not comprise an actuator.

In some embodiments, the one or more parameters of the end effector comprise at least one of an acceleration, a direction, a pose, or a speed of a portion of the end effector, and the one or more sensors are configured to sense the at least one of the acceleration, the direction, the pose, or the speed of the portion of the end effector. In some such embodiments, the one or more sensors coupled to the end effector comprise one or more encoders and/or one or more inertial measurement units coupled to the end effector, and the one or more encoders and/or the one or more inertial measurement units is/are configured to sense the at least one of the acceleration, the direction, the pose, or the speed of the portion of the end effector, and output the one or more signals indicative of the at least one of the acceleration, the direction, the pose, or the speed of the portion of the end effector.

In some embodiments, the apparatus further comprises a limb connected to the end effector, and one or more second sensors coupled to the limb. In some such embodiments, the one or more second sensors are configured to sense one or more second parameters of the limb, and output one or more second signals indicative of the one or more second parameters.

In some embodiments, the one or more parameters comprise a force applied by a portion of the end effector to the object, and the one or more sensors coupled to the end effector comprise one or more tactile sensors disposed on one or more contact pads of the end effector. In some such embodiments, the one or more tactile sensors are configured to sense the force applied by the portion of the end effector to the object, and output the one or more signals indicative of at least the sensed force.

In some embodiments, the apparatus further comprises one or more image sensors configured to capture a stream of images of at least one of the end effector, the object, or the surrounding environment during manipulation of the object; and output the stream of images.

In some embodiments, the apparatus performs at least in part a method for training a robotic system. Alternatively, a different apparatus and/or system may perform at least in part the method. In some embodiments, the method comprises manually manipulating, using a passive exoskeleton, one or more parameters of an end effector to manipulate an object. The method further comprises transmitting, using one or more linkages of the passive exoskeleton, forces applied to the end effector to a portion of a user's body due to interactions of the end effector with a surrounding environment. The method additionally comprises sensing, using one or more sensors, one or more parameters of the end effector while facilitating manipulation of the object to generate a training dataset for operation of the robotic system.

In some embodiments, the method further comprises receiving, using at least one communication interface, one or more signals indicative of the one or more parameters of the end effector, and generating, using one or more hardware processors and the one or more parameters, the training dataset for operation of the robotic system. In some such embodiments, the method further comprises generating, using the one or more hardware processors and the training dataset, machine readable instructions for operation of the robotic system in accordance with the training dataset, and outputting, using the at least one communication interface, the machine readable instructions to the robotic system for operation of the robotic system.

In some embodiments, the method further comprises operating the robotic system in accordance with the training dataset and using the one or more parameters during manipulation of the object or a different object.

In some embodiments, the method further comprises capturing, using at least one image sensor, a stream of images of at least one of the end effector, the object, or the surrounding environment during manipulation of the object, and generating, using one or more hardware processors and the stream of images, the training dataset for operation of the robotic system.

In some embodiments, the disclosed apparatus and/or systems include at least one computer-readable storage medium. In some such embodiments, the computer-readable storage medium stores processor executable instructions that, when executed by at least one hardware processor, cause the at least one hardware processor to receive, using at least one communication interface, sensor data from one or more sensors configured to sense one or more parameters of an end effector when the end effector is manually manipulated by a passive exoskeleton to manipulate an object, generate, using the sensor data, a training dataset for operation of a robotic system comprising the end effector, and cause a change in the one or more parameters of the end effector to manipulate the object in accordance with the training dataset.

In some embodiments, the processor executable instructions cause the at least one hardware processor to receive one or more signals indicative of the one or more parameters of the end effector, and generate, using the one or more parameters, a training dataset for operation of the robotic system.

In some embodiments, the processor executable instructions are first processor executable instructions and cause the at least one hardware processor to generate second processor executable instructions for operation of the robotic system in accordance with the training dataset, and output the second processor executable instructions to the robotic system for operation of the robotic system.

In some embodiments, the one or more parameters comprise at least one of motion data, pose data, or force data associated with the end effector, and the processor executable instructions cause the at least one hardware processor to receive, from at least one image sensor, a stream of images of at least one of the end effector, the object, or an environment during manipulation of the object, and generate, using the at least one of the motion data, the pose data, the force data, or the stream of images, the training dataset for operation of the robotic system.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

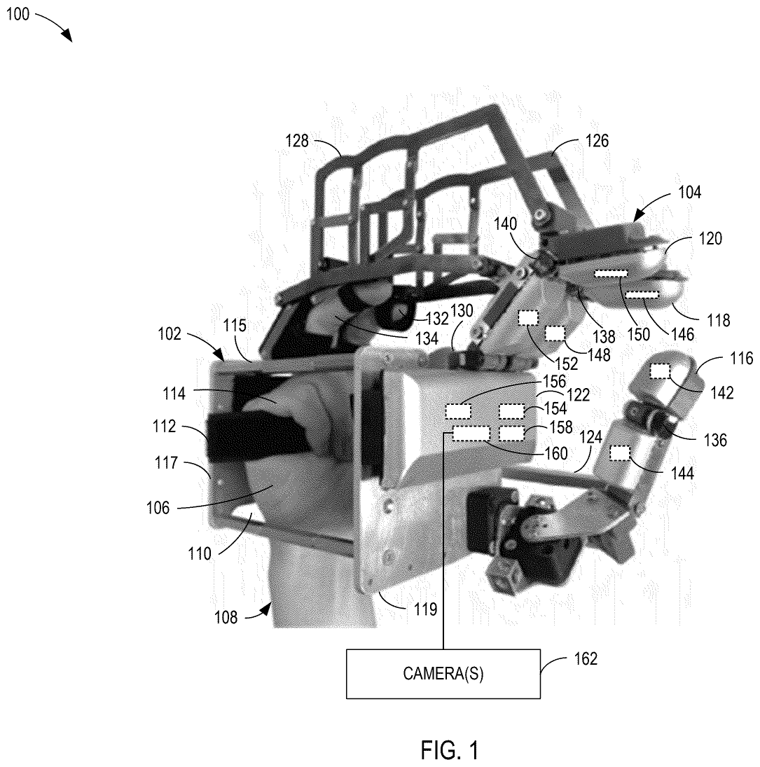

Turning to the figures, the illustrated example of FIG. 1 shows an example robotic training system 100 (or “robot training system”) including an exoskeleton 102 and an end effector 104. The end effector 104 is configured to be manually manipulated by a portion 106 of a body of a user 108 using the exoskeleton 102. As shown, the portion 106 of the body of the user 108 is a hand (e.g., a human hand). The shown hand includes five fingers including a thumb, an index finger, a middle finger, a ring finger, and a little finger (e.g., a pinky finger).

Although embodiments disclosed herein are discussed in connection with a human hand, the disclosure is not limited thereto. The techniques disclosed herein are applicable to other human body parts, such as heads, necks, chests, arms, legs, feet, and portion(s) thereof (e.g., elbows, knees, toes). For example, the exoskeleton 102, the end effector 104, and/or, more generally, the robotic training system 100, can be configured for a human foot.

The robotic training system 100 is configured to train a robot, or robotic portion(s) thereof, to perform dexterous manipulation tasks. A dexterous manipulation task is a task performed using at least one body part, such as at least one hand, to manipulate an object. A robot performing a dexterous manipulation task can thereby include the robot autonomously performing the dexterous manipulation task using the end effector 104. The task can be autonomously performed by being performed without human intervention (e.g., without the user 108 manipulating the end effector 104).

Examples of dexterous manipulation tasks include drilling a hole using a power drill, installing a component such as a light bulb into a socket, opening or closing a box, and opening or closing a container (e.g., a bottle, a can, a vessel). For example, a robot can be trained as disclosed herein to use the end effector 104 to install a light bulb into a socket.

The exoskeleton 102 of this example is a passive exoskeleton configured to be manipulated by the user 108 to interact with an object (not shown). The exoskeleton 102 may be a passive exoskeleton that does not include an actuator (e.g., an electro-mechanical actuator). However, instances in which one or more actuators are included in some embodiments are also contemplated.

The robotic training system 100 shown in FIG. 1 is an example and other examples are contemplated. For example, the robotic training system 100 may include any passive exoskeleton configured to be attached to a portion of a person's body to enable the passive exoskeleton to be manipulated to interact with a desired end effector, a desired environment, and/or any combination(s) thereof, to perform a target task. In such an example, the robotic training system 100 may include a passive exoskeleton configured to be attached to a person's arm, torso, leg, and/or foot to enable the passive exoskeleton to be manipulated by the person to interact with a desired end effector (e.g., a mechanical arm, a mechanical torso, etc.), a desired environment, and/or any combination(s) thereof.

The exoskeleton 102 is a wearable exoskeleton configured to receive the hand 106. The exoskeleton 102 of this example is a passive wearable exoskeleton that includes a handle configured to be grasped by a user's hand and one or more interfaces configured to engage with one or more fingers of the user to manipulate one or more corresponding moveable fingers of the exoskeleton 102.

As shown, the hand 106 can be inserted into an opening 110 and through a hand strap 112 of the exoskeleton 102. Fingers 114 of the hand 106 can be inserted into respective portions of the exoskeleton 102 such that the user 108 can move their fingers 114 to change one or more parameters of the end effector 104. At least some of the fingers 114 can be curled around the hand strap 112 to stabilize the hand 106 while other one(s) of the fingers 114 manipulate the exoskeleton 102. The exoskeleton 102 is attached to the end effector 104 by coupling standoffs 115 between a base 117 (e.g., a base structure) of the exoskeleton 102 and a base 119 (e.g., a base structure) of the end effector 104. The handle of the exoskeleton 102 may include the hand strap 112 and the base 117.

The end effector 104 of this example is a hand (e.g., a mechanical hand) including a plurality of hand portions. The plurality of hand portions shown is a plurality of fingers 116, 118, 120 and a palm 122. The fingers 116, 118, 120 include a thumb 116, a index finger 118, and a middle finger 120. The fingers 116, 118, 120 may be mechanical fingers including a mechanical thumb, a mechanical index finger, and a mechanical middle finger. Alternatively, the end effector 104 may include fewer or more hand portions than shown in FIG. 1.

The end effector 104 features 7 fully actuated degrees of freedom (DoF): 2 for the index finger 118 and the middle finger 120, respectively, and 3 for the thumb 116. Both the index finger 118 and the middle finger 120 have a 1 DoF metacarpophalangeal (MCP) joint and a proximal interphalangeal (PIP) joint. The thumb 116 has a 2 DoF trapeziometacarpal (TM) joint and an interphalangeal (IP) joint.

As shown, the exoskeleton 102 is coupled (e.g., operatively coupled) to the end effector 104 through one or more linkage systems 124, 126, 128. The force applied to the exoskeleton 102 by fingers of the user 108 is transmitted to the end effector 104, driving its movement. Similarly, the force exerted on the end effector 104 during interaction with the environment is transmitted to the hand of the user 108 through the linkage systems 124, 126, 128 and exoskeleton attachments.

The linkage systems 124, 126, 128 include a first linkage system 124, a second linkage system 126, and a third linkage system 128. The first linkage system 124 is configured to couple a thumb 130 of the user 108 to the thumb 116. The second linkage system 126 is configured to couple an index finger 132 of the user 108 to the index finger 118. The third linkage system 128 is configured to couple a middle finger 134 of the user 108 to the middle finger 120.

The end effector 104 of this example includes a plurality of sensors 136, 138, 140, 142, 144, 146, 148, 150, 152, 154, 156, 158. The sensors 136, 138, 140, 142, 144, 146, 148, 150, 152, 154, 156, 158 can be configured to determine (e.g., sense, measure) one or more parameters of the end effector 104 in response to manipulation by the user 108 via the exoskeleton 102. Some sensors are not shown for enhanced clarity.

In some embodiments, one(s) of the plurality of sensors 136, 138, 140, 142, 144, 146, 148, 150, 152, 154, 156, 158 can be an encoder. For example, an encoder (e.g., a position encoder) can be coupled to each revolute joint of each finger 116, 118, 120 to measure the joint angle. As shown, a first sensor 136 is an encoder coupled to a joint of the thumb 116, a second sensor 138 is an encoder coupled to a joint of the index finger 118, and a third sensor 140 is an encoder coupled to a joint of the middle finger 120.

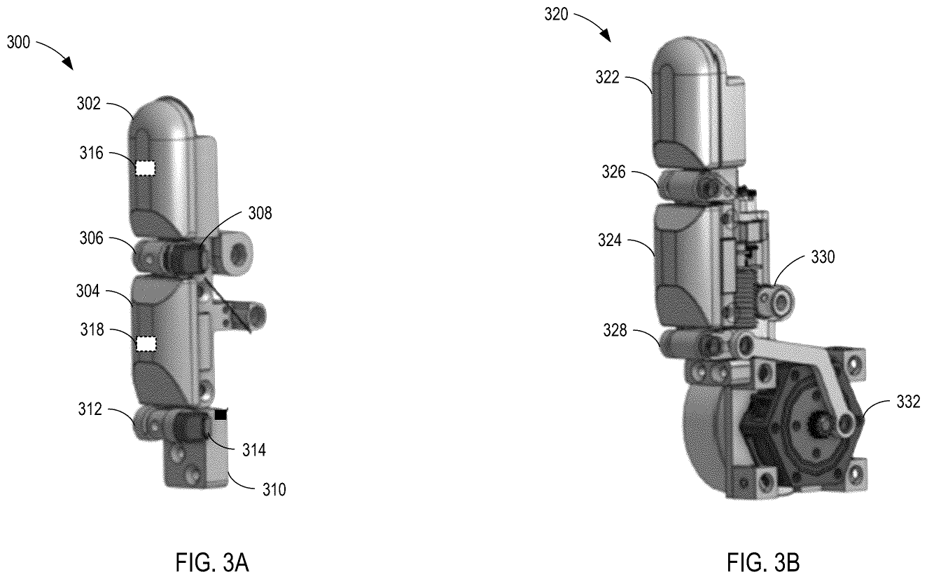

In some embodiments, the end effector 104 may include fewer or more encoders than shown. For example, the thumb 116, the index finger 118, and/or the middle finger 120 may respectively include multiple encoders such that each finger joint may be coupled to an encoder. In such an example, the thumb 116, the index finger 118, and/or the middle finger 120 can respectively correspond to the finger 300 shown in FIG. 3A, which includes multiple encoders.

In some embodiments, one(s) of the plurality of sensors 136, 138, 140, 142, 144, 146, 148, 150, 152, 154, 156, 158 can be a tactile sensor. For example, as shown, a fourth sensor 142 is a tactile sensor included in a first finger segment (e.g., a fingertip) of the thumb 116 and a fifth sensor 144 is a tactile sensor included in a second finger segment of the thumb 116. As shown, a sixth sensor 146 is a tactile sensor included in a first finger segment (e.g., a fingertip) of the index finger 118 and a seventh sensor 148 is a tactile sensor included in a second finger segment of the index finger 118. Further, as shown, an eighth sensor 150 is a tactile sensor included in a first finger segment (e.g., a fingertip) of the middle finger 120 and a ninth sensor 152 is a tactile sensor included in a second finger segment of the middle finger 120. Additionally, as shown, a tenth sensor 154 is a tactile sensor included in a first palm segment of the palm 122 and an eleventh sensor 156 is a tactile sensor included in a second palm segment of the palm 122.

In some embodiments, the tactile sensors 142, 144, 146, 148, 150, 152, 154, 156 equip the end effector 104 with full-hand tactile sensing capability. The tactile sensors 142, 144, 146, 148, 150, 152, 154, 156 of this example are camera-based tactile sensors. For example, the tactile sensors 142, 144, 146, 148, 150, 152, 154, 156 can respectively include at least one camera, at least one illumination source (e.g., at least one light-emitting diode (LED)), and at least one diffuser. The camera can be configured with a fisheye lens. The at least one illumination source can be configured as an LED strip. In some embodiments, the tactile sensors 142, 144, 146, 148, 150, 152, 154, 156 include at least one camera driver board connected to the at least one camera via at least one cable. Alternatively, the at least one camera driver board may be remote to the tactile sensors 142, 144, 146, 148, 150, 152, 154, 156. For example, the at least one camera driver board for one or more of the tactile sensors 142, 144, 146, 148, 150, 152, 154, 156 can be included in the palm 122 or elsewhere on the end effector 104.

The finger and palm segments of the end effector 104 are tactile surfaces each with varying morphologies and can be configured to stream a total of 8 images, one for each finger and palm segment. Alternatively, a different number of images may be streamed for one(s) of the finger and/or palm segments.

In some embodiments, the tactile sensors 142, 144, 146, 148, 150, 152, 154, 156 can be configured to perform three-dimensional (3D) reconstruction of the sensing surface via photometric stereo. In some such embodiments, this can be achieved by configuring the tactile sensors 142, 144, 146, 148, 150, 152, 154, 156 to illuminate the sensing surface (from the interior of the finger/palm segment) with a number (e.g., 1, 2, 3, 4, etc.) of different colored directional light sources spaced as evenly apart as possible around the tactile sensor while minimizing their angle of elevation to the sensing surface.

In some embodiments, the tactile sensors 142, 144, 146, 148, 150, 152, 154, 156 are configured to use directional lighting for sensing. In some embodiments, the tactile sensors 142, 144, 146, 148, 150, 152, 154, 156 are configured to side illuminate the perimeter of a diffuser to provide non-directional overhead lighting to a semi-specular sensing surface, which can give geometric information about the object in contact while eliminating casted shadows. In some such embodiments, side illuminating the parameter can achieve increased data throughput by only transmitting a single channel image.

In some embodiments, to simulate the tactile sensors, pixel-wise inference can be performed via a machine learning (ML) model (e.g., a multilayer perceptron (MLP)) that takes as input surface normal and viewing direction augmented with positional encoding of a simulated deformation, and outputs the estimated red-green-blue (RGB) value. The RGB value can be processed into detailed feedback on object geometry and contact forces. In some embodiments, an end effector controller 160 can receive sensor data output from the tactile sensors 142, 144, 146, 148, 150, 152, 154, 156 and process, using the ML model, the sensor data into the outputs indicative of the estimated RGB value(s).

In some embodiments, one(s) of the plurality of sensors 136, 138, 140, 142, 144, 146, 148, 150, 152, 154, 156, 158 can be an inertial measurement unit (IMU). As shown, a twelfth sensor 158 is an IMU included in the palm 122. The palm 122 may include multiple IMUs.

In some embodiments, the end effector 104 includes one or more IMUs elsewhere in the end effector 104 than shown in FIG. 1. For example, the thumb 116, the index finger 118, and/or the middle finger 120 may respectively include one or more IMUs.

The IMU 158 can be configured to measure pose, linear acceleration, angular velocity, and/or magnetic fields of the palm 122 and/or, more generally, the end effector 104. For example, the IMU 158 can implement an accelerometer configured to measure linear acceleration (e.g., a rate of change of velocity over time), a gyroscope configured to measure angular velocity (e.g., a rate of rotation and/or speed of change in orientation), and/or a magnetometer configured to measure a strength and direction of magnetic fields (e.g., a compass heading reference).

In some embodiments, the IMU 158 implements a single-axis accelerometer that measures acceleration along one direction. In some embodiments, the IMU 158 implements a multi-axial accelerometer that measures acceleration along multiple directions. The multi-axial accelerometer can be a triaxial accelerometer that measures acceleration along three orthogonal directions (e.g., X, Y, and Z directions). In some such embodiments, the IMU 158 can determine a direction of the palm 122 and/or, more generally, the end effector 104 along one or more directions (e.g., X, Y, and/or Z directions).

The gyroscope can be configured to determine rotational information such as data on the pitch, roll, and yaw of the palm 122 and/or, more generally, the end effector 104. In some embodiments, the output(s) of the accelerometer(s), the gyroscope(s), and/or the magnetometer(s) of the IMU 158 can be processed into a pose of the palm 122, and/or, more generally, the end effector 104.

The robotic training system 100 of the illustrated example further includes one or more cameras 162. The camera(s) 162 can be configured to capture images of the user 108, the exoskeleton 102, the end effector 104, and/or an environment surrounding the user 108, the exoskeleton 102, and the end effector 104. The camera(s) 162 can capture still images (e.g., an image stream, a rapid sequence of images) and/or video. The camera(s) 162 is/are shown as configured to output images/video to the end effector controller 160.

In some embodiments, the end effector controller 160 receives one or more signals indicative of one or more parameters of the end effector 104. For example, the plurality of sensors 136, 138, 140, 142, 144, 146, 148, 150, 152, 154, 156, 158 can respectively output one or more signals indicative of parameters measured by the respective sensor.

Examples of the parameters include an acceleration, a direction, a pose, and a speed of a portion of the end effector 104. Examples of the portion of the end effector 104 include a finger segment, a finger, a palm segment, a palm, and/or an entirety of the end effector 104.

In some embodiments, the end effector controller 160 is implemented by at least one programmable processor. Examples of programmable processors include central processing units (CPUs), digital signal processors (DSPs), field programmable gate arrays (FPGAs), and graphics processing units (GPUs). In some embodiments, the end effector controller 160 is implemented by one or more first programmable processors of a first type (e.g., one or more CPUs) and one or more second programmable processors of a second type (e.g., one or more FPGAs), different from the first type.

Although not shown for enhanced clarity, the end effector controller 160 is in communication with the plurality of sensors 136, 138, 140, 142, 144, 146, 148, 150, 152, 154, 156, 158 such that the end effector controller 160 can receive sensor data therefrom. For example, the end effector controller 160 can be in communication with ones of the plurality of sensors 136, 138, 140, 142, 144, 146, 148, 150, 152, 154, 156, 158 via at least one bus. The at least one bus can be any type of computing and/or electrical bus. Examples of computing and/or electrical busses include an Inter-Integrated Circuit (I2C) bus, a Peripheral Component Interconnect (PCI) bus, a Peripheral Component Interconnect Express (PCIe) bus, a Serial Peripheral Interface (SPI) bus, a Universal Chiplet Interconnect Express (UCIe) bus, and a Universal Asynchronous Receiver/Transmitter (UART) bus.

In some embodiments, the end effector controller 160 generates a training dataset for operation of a robotic system using the one or more parameters of the end effector 104. Examples of the robotic system include a robotic limb, such as a robotic arm, that includes the end effector 104 and a robot that includes the robotic limb. In some embodiments, the end effector 104 can be configured with one or more actuators operatively coupled to one or more respective portions of the end effector 104 and configured to change one or more parameters of the end effector 104 in accordance with the training dataset.

Beneficially, the robotic training system 100 is configured with several advantageous features to facilitate intuitive interaction and effective learning. The robotic training system 100 ensures kinematic transparency, so users, such as the user 108, can operate the end effector 104 within its full workspace without interference. Force feedback from the end effector 104 is transmitted accurately to at least some of the fingers 114, enabling precise manipulation and grip control. Furthermore, the robotic training system 100 includes and/or incorporates a tactile sensor system including the tactile sensors 142, 144, 146, 148, 150, 152, 154, 156, allowing the collection of detailed force and contact information during interaction. Beneficially, these advantageous features enable the gathering of a rich corpus of training data that can be used to generate a training dataset to train and/or operate robots and/or robotic systems to perform tasks requiring high precision and dexterity.

Unlike conventional exoskeletons, which are designed to provide humans with external forces through actuators, the robotic training system 100 takes the opposite approach involving the passive exoskeleton 102 actuated by the user 108 to drive the hand 104. This approach achieves benefits related to kinematic transparency, workspace constraints, kinematic mirroring, dynamic transparency, and force transparency.

With respect to kinematic transparency, the exoskeleton 102 allows the user 108 to move freely in a workspace of the end effector 104, without causing collision of the end effector 104 to human hand.

With respect to workspace constraints and for the workspace beyond the reachability of the end effector 104, the exoskeleton 102 provides constraints to the human hand, such that the data collected by the user 108 can always be valid for a robot to directly imitate.

With respect to kinematic mirroring, when the user 108 configures the human hand to a specific posture within the workspace of the end effector 104, the exoskeleton 102 drives the end effector 104 to a similar posture. Such mirroring allows intuitive control of the end effector 104 without extra training.

With respect to dynamic transparency, the robotic training system 100 has relatively low inertia/friction so that the user 108 can move their hand without internal forces caused by finger movement. This achieves the benefit of reducing effort on behalf of the user 108. Further, the user 108 can sense the feedback force from the environment more accurately without the influence of internal force.

With respect to force transparency, the exoskeleton 102 properly transmits the force applied on the robot finger to the human finger, and vice versa to allow the user 108 to apply forces to the environment through the robot finger. The force applied to different phalanges of the end effector 104 are transmitted to corresponding parts on the human hand for intuitive haptic feedback.

The robotic training system 100 of FIG. 1 achieves further benefits with respect to force output, workspace coverage, and finger speed. With respect to force output, the robotic training system 100 can transmit force effectively between the human hand and the hand. For example, in some experiments under certain operating conditions, a peak force of around 60 Newtons (N) at the index and middle fingers and around 80 N at the thumb have been measured, which is comparable to the hand's force capabilities, and sufficient for manipulating various objects. The force of the exoskeleton 102 is also related to the human subject that is wearing it, and it has been observed that the linkage system described in further detail below can transmit the force with high efficiency.

With respect to workplace coverage the robotic training system 100 mirrors the workspace of the hand, achieving nearly full articulation for dexterous manipulation tasks.

For example, in some experiments under certain operating conditions, the MCP joint on both the exoskeleton 102 and the end effector 104 covers approximately 110-120 degrees of flexion, while the PIP joints allow for 105 degrees. The thumb's motion on the exoskeleton 102 substantially matches the hand's workspace on all three joints.

Finger speed can be measured to assess how quickly the robotic training system 100 responds to human input. For example, in some experiments under certain operating conditions, the MCP joint achieves a maximum angular velocity of 35 radians per second (rad/s) on the robotic training system 100. The PIP and IP joints on the robotic training system 100 reach velocities of 15 rad/s and 9 rad/s, respectively, which can be 2-3 times faster than those of a robotic training system including only a hand.

Beneficially, the robotic training system 100 of FIG. 1 implements a hand exoskeleton system that enhances dexterous manipulation and enables scalable data collection in real-world environments. By incorporating kinematic mirroring, force transparency, and tactile sensors, the robotic training system 100 overcomes the technological challenges of conventional robotic training systems, such as teleoperation-based training systems, by providing intuitive control and high-quality data.

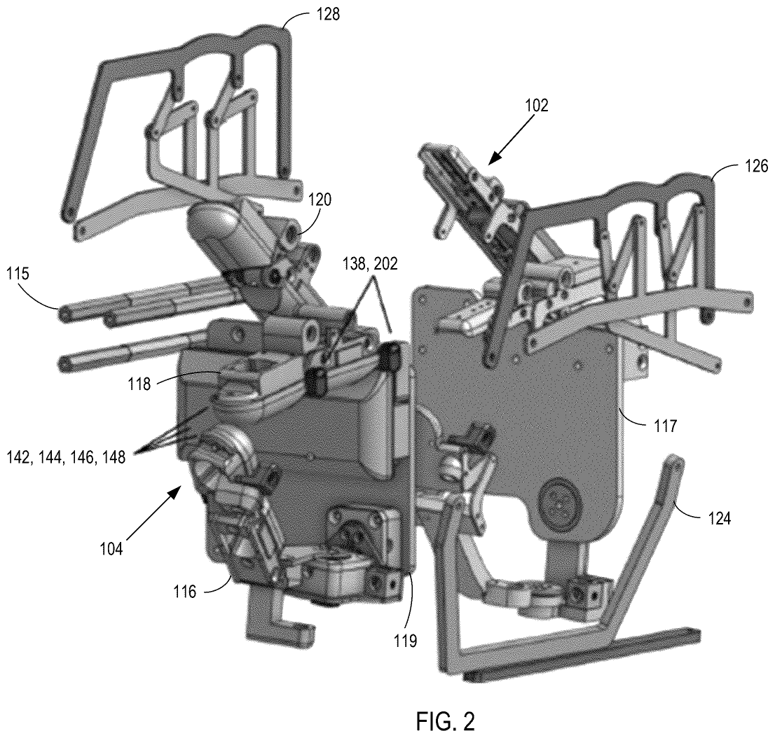

FIG. 2 shows an exploded view of the end effector 104 and the passive exoskeleton 102 of FIG. 1. Some reference numerals from FIG. 1 are omitted in FIG. 2 for enhanced clarity but are applicable to FIG. 2. For example, only a portion of the tactile sensors 142, 144, 146, 148, 150, 152, 154, 156 are identified and/or shown in FIG. 2 but the end effector 104 shown in FIG. 2 includes the same. Further shown in FIG. 2 is an encoder 202 coupled between finger segments of the index finger 118.

FIG. 3A shows a first finger 300. The first finger 300 is a passive finger because it may not include any actuators (e.g., electro-mechanical actuators).

In some embodiments, the first finger 300 is a passive portion of an end effector. For example, the first finger 300 can be a passive finger of the end effector 104 of FIG. 1. In such an example, the first finger 300 can correspond to and/or implement the thumb 116, the index finger 118, and/or the middle finger 120 of FIGS. 1 and/or 2.

As shown, the first finger 300 includes a first finger segment 302 and a second finger segment 304. The first finger segment 302 includes a fingertip. The first finger segment 302 is coupled to the second finger segment 304 via a first rotatable joint 306.

As shown, a first encoder 308 is coupled to the first rotatable joint 306 to measure joint state information. The first encoder 308 can be a position encoder (e.g., an angular encoder). Examples of joint state information include a pose and an acceleration of the first finger segment 302 with respect to the second finger segment 304 and/or, more generally, an end effector (e.g., a hand) that includes the first finger segment 302 and the second finger segment 304.

The second finger segment 304 is coupled to a mounting bracket 310 via a second rotatable joint 312. For example, the first finger 300 can be coupled to an end effector via the mounting bracket 310. A second encoder 314 is coupled to the second rotatable joint 312 to measure a pose and/or acceleration of the second finger segment 304 with respect to the mounting bracket 310 and/or, more generally, an end effector (e.g., a hand) that includes the first finger segment 302 and the second finger segment 304. The second encoder 314 can be a position encoder (e.g., an angular encoder) configured to measure joint state information.

The first finger 300 of this example further includes a first tactile sensor 316 and a second tactile sensor 318. The first tactile sensor 316 can be included in and/or integrated with the first finger segment 302. The second tactile sensor 318 can be included in integrated and/or integrated with the second finger segment 304.

In some embodiments, the first tactile sensor 316 can correspond to a tactile sensor shown in FIG. 1, such as the tactile sensor 146. In some embodiments, the second tactile sensor 318 can correspond to a tactile sensor shown in FIG. 1, such as the tactile sensor 148.

FIG. 3B shows a second finger 320. The second finger 320 includes a first finger segment 322 coupled to a second finger segment 324 via a first rotatable joint 326. The second finger segment 324 is coupled to a second rotatable joint 328.

The second finger 320 is a robotic finger (e.g., an active robotic finger) because it may include one or more actuators 330, 332. The actuators 330, 332 of this example are motors (e.g., electro-mechanical motors) configured to move the finger segments 322, 324.

As shown, the actuators 330, 332 include a first actuator 330 and a second actuator 332. The first actuator 330 is coupled to the first and second rotatable joints 326, 328. The second actuator 332 is coupled to the second rotatable joint 328.

In some embodiments, the second finger 320 is an active portion of an end effector. For example, the second finger 320 can be an active robotic finger in an embodiment in which one or more of the fingers of the end effector 104 of FIG. 1 are active robotic fingers. In such an example, the second robotic finger 320 can correspond to and/or implement the active robotic finger(s).

In some embodiments, the first finger 300 is kinematically identical to the second finger 320, even though the first finger 300 is passively driven and the second finger 320 is actively driven.

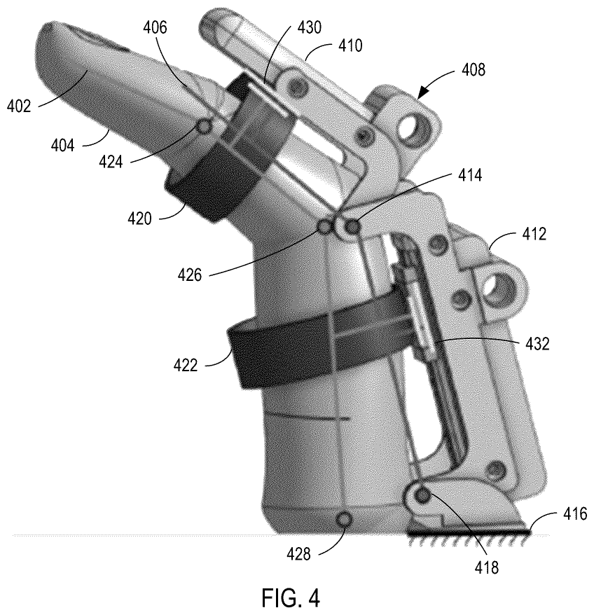

FIG. 4 shows a first example kinematic chain 402 for a human finger 404 and a second kinematic chain 406 for an exoskeleton finger portion 408. In some embodiments, the kinematic chains 402, 406 can correspond to the kinematic chains shown in FIG. 1. In some such embodiments, the first kinematic chain 402 can correspond to a kinematic chain for the index finger 132 of the user 108 and the second kinematic chain 406 can correspond to a kinematic chain for the portion of the exoskeleton 102 associated with the index finger 132.

As shown, the exoskeleton finger portion 408 includes a first exoskeleton finger segment 410 and a second exoskeleton finger segment 412. The first exoskeleton finger segment 410 is coupled to the second exoskeleton finger segment 412 via a first rotatable joint 414. The second exoskeleton finger segment 412 is coupled to a mounting structure 416 (e.g., a mounting bracket) via a second rotatable joint 418. The first exoskeleton finger segment 410 includes a first strap 420 and the second exoskeleton finger segment 412 includes a second strap 422 through which the finger 404 is inserted.

As shown, the kinematics of the exoskeleton finger portion 408 match the kinematics of the human finger 404. For example, kinematic nodes 424, 426, 428 of the human finger 404 form the first kinematic chain 402 that substantially corresponds to the nodes at the rotatable joints 414, 418 that form the second kinematic chain 406. Sliding joints 430, 432 in this example serve as compensatory mechanisms, ensuring that despite the differences in size, shape, and range of motion between the human hand 404 and the corresponding finger (not shown), the exoskeleton finger portion 408 and/or, more generally, the exoskeleton 102 of FIG. 1, can still perform synchronized and natural movements.

As disclosed herein and shown at least in part in FIG. 4, the wearable exoskeleton 102 is configured to align the kinematic chain of the exoskeleton 102 in parallel to the kinematic chain of the human finger 404, ensuring maximum range of motion for the human fingers. This alignment allows users to intuitively control the hand 104. It has been contemplated within the context of this disclosure that achieving this is challenging because the distance between the MCP and PIP joints on the exoskeleton 102 is fixed and closely matches the length of the human proximal phalanx. As a result, whether the exoskeleton 102 overlays the human finger or vice versa, interference tends to occur when the finger bends.

In some embodiments, to overcome this technical challenge and to accommodate the human fingers, the joints are positioned to the side of the finger and connected with spring steel (e.g., 1 millimeter (mm), 1.5 mm, 2 mm, etc., spring steel). To provide additional support and create an attachment point for the human phalanges, the linkages are curved around the back of the finger and connected to a 3D-printed finger backing. The human fingers are then attached to the finger backing through a linear slider (e.g., the sliding joints 430, 432), which compensates for relative sliding between the exoskeleton 102 and the finger 404.

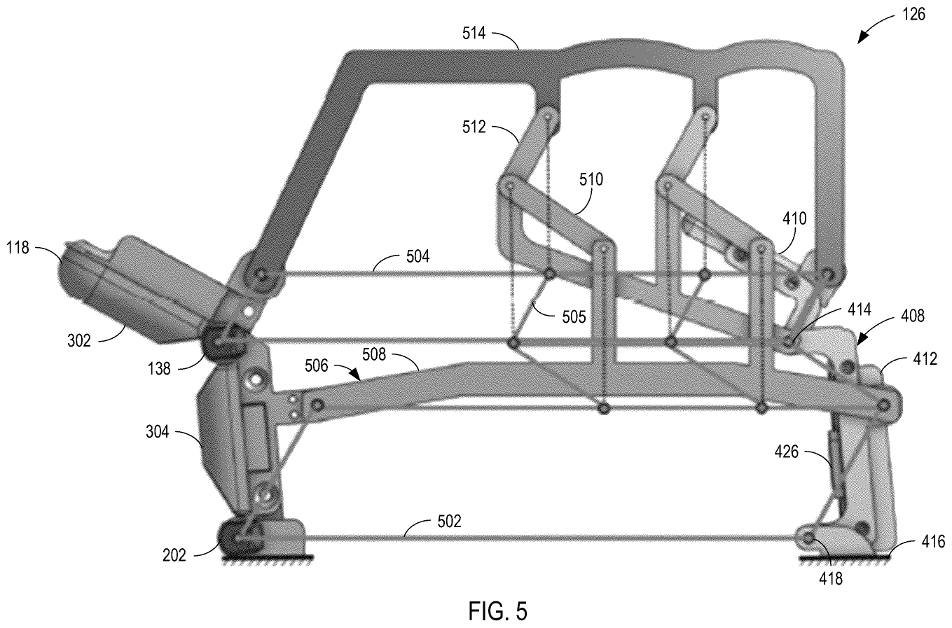

FIG. 5 shows a side view of the second linkage system 126 of FIGS. 1 and/or 2 coupling the index finger 118 to the exoskeleton finger portion 408. In some embodiments, the technical details discussed in connection with FIG. 5 are likewise applicable to the third linkage system 128 of FIGS. 1 and/or 2. For example, the components shown in FIG. 5 and their corresponding configuration and operation are applicable to the second linkage system 126 and the third linkage system 128.

The exoskeleton finger portion 408 is configured to receive a human user's index finger (not shown). As shown, the second linkage system 126 includes a first 4-bar linkage system 502 and a second 4-bar linkage system 504. The first and second 4-bar linkage systems 502, 504 are parallel 4-bar linkage systems. Further shown are auxiliary linkage systems 505 having virtual joints that correspond to actual joints of the second linkage system 126.

The first 4-bar linkage system 502 includes a first linkage 506. The first linkage 506 is a rigid linkage having a first rigid portion 508 operatively coupled to a second rigid portion 510. The first rigid portion 508 is operatively coupled to the second finger segment 304 of the index finger 118 and the second exoskeleton finger segment 412. The second rigid portion 510 is operatively coupled to a second rigid linkage 512.

The second 4-bar linkage system 504 includes the second rigid linkage 512 operatively coupled to the first exoskeleton finger segment 410, the second rigid portion 510 of the first linkage 506, and a third rigid linkage 514. The third rigid linkage 514 is operatively coupled to the first finger segment 302 and the first exoskeleton finger segment 410.

In example operation, the hand 104 is driven by the exoskeleton 102 at least in part through the second linkage system 126. Beneficially, since the wearable exoskeleton 102 shares substantially the same kinematics as the hand 104, the second linkage system 126 can be configured using multiple parallel 4-bar linkages as shown in FIG. 5 for simplicity.

As discussed above, the linkage system for both the index and middle fingers is shown in FIG. 5. As shown, the second linkage system 126 includes two parts, the first being the two serial 4-bar linkage systems 502, 504 to drive the two finger phalanges and the second being the auxiliary linkage systems 505. The fixed distance between the MCP joint of the exoskeleton 102 and that of the hand 104 serves as the virtual fixed frame. The exoskeleton's proximal phalanx acts as the input link, and the robot's proximal phalanx acts as the output link. Beneficially, to prevent the coupler from colliding with the hand 104 during movement, the rigid linkages 506, 512, 514 are configured with curved shapes.

Beneficially, with these 4-bar linkage systems 502, 504, the distance between the PIP joints of the hand 104 and the exoskeleton 102 is also fixed, enabling the 4-bar linkage systems 502, 504 to be configured similarly for the middle phalanx.

It has been recognized within the context of this disclosure that linkage systems could enter a contra-parallelogram state, where the output link moves in the opposite direction when the input link crosses the singularity. In a typical parallelogram 4-bar system, the workspace is constrained to less than 180 degrees to avoid singularity. However, the finger requires a larger workspace. To overcome this technical challenge with parallelogram 4-bar systems, the second linkage system 126 (and the first linkage system 124) is configured with the auxiliary linkage systems 505 to ensure both 4-bar linkage systems 502, 504 work in parallel. The auxiliary linkage systems 505 include the second rigid linkage 512 connected to the couplers of the two 4-bar linkage systems 502, 504 by three parallel links. This forms a parallel 5-bar linkage with a 360-degree workspace. Parallelism is maintained by transmitting motion from one coupler, through the second rigid linkage 512, to the other coupler. The shapes of the linkage systems 502, 504, 505 are also configured to avoid collisions between the connecting rivets and the linkages.

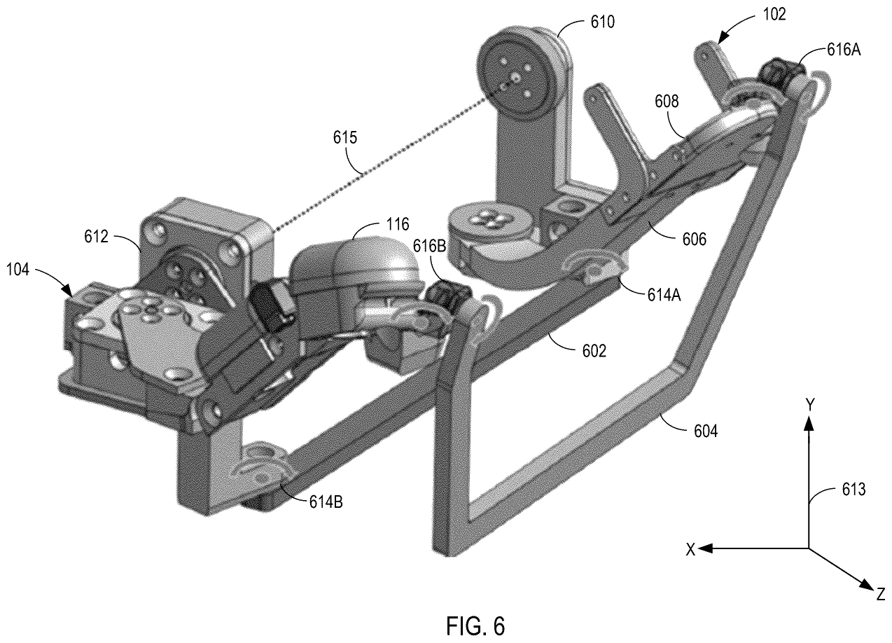

FIG. 6 shows a perspective view of example linkage systems 602, 604 coupling the thumb 116 of the end effector 104 and the exoskeleton 102 of FIGS. 1 and/or 2. The linkage systems 602, 604 include a first linkage system 602 operatively coupled to the thumb 116 and a thumb portion 606 of the exoskeleton 102, which is configured to receive the thumb 130 of the user 108 of FIG. 1. The linkage systems 602, 604 include a second linkage system 604 operatively coupled to the thumb 116 and the thumb portion 606 of the exoskeleton 102.

As shown, the thumb portion 606 includes a first portion 608 configured to receive the thumb 116 and a second portion 610 configured to attach and/or mount to the base 117 of the exoskeleton 102. For example, the second portion 610 can be attached/mounted to the base 117 via welding and/or one or more fasteners.

The thumb 116 is mounted to the base 119 of the end effector 104 via a mounting portion 612. For example, the mounting portion 612 can be attached to the base 119 via welding and/or one or more fasteners. As shown, the second portion 610 is coaxial with the mounting portion 612 of the thumb 116.

In this example, an X-axis and a Y-axis of a coordinate plane 613 is co-planar with a coaxial line 615 shown. A Z-axis of the coordinate plane 613 is perpendicular to the coaxial line 615 shown. For example, a height of the second portion 610 can be along the Z-axis of the coordinate plane 613.

In the illustrated example, the first linkage system 602 includes revolute joints 614A, 614B (collectively “614”). The revolute joints 614 are rotary joints that rotate around the X-and Y-axes of the coordinate plane 613. For example, the revolute joints 614 are configured to enable the thumb portion 608 of the exoskeleton 102 of FIG. 1 to swivel and/or rotate about the X-and Y-axes of the coordinate plane 613. In such an example, the revolute joints 614 can be actuated to transmit forces between the thumb portion 608 of the exoskeleton 102 and the thumb 116 along the X-and Y-axes.

The second linkage system 604 includes serial revolute joints 616A, 616B (collectively “616”). Each of the serial revolute joints 616 implement a series of links connected by two revolute joints. For example, the serial revolute joints 616 are configured to enable the thumb portion 608 of the exoskeleton 102 of FIG. 1 to swivel and/or rotate about the Z-axis of the coordinate plane 613. In such an example, the serial revolute joints 616 can be actuated to transmit forces between the thumb portion 608 of the exoskeleton 102 and the thumb 116 along the Z-axis and at least one of the X-and Y-axes of the coordinate plane 613.

As discussed above in connection with FIG. 5, the wearable exoskeleton 102 can be configured to substantially match the kinematic chain of the hand 104, allowing the hand 104 to be driven using simple parallel 4-bar linkage structures. As shown in FIG. 6, the length between the two axes of the TM joint of the thumb is configured to prevent collisions with the user's thumb 130 when wearing the exoskeleton 102. The thumb length is extended accordingly to ensure that the position of the IP joint remained unaffected in the kinematic chain.

The TM joint for the thumb 130 includes two perpendicular axes, and the abduction joint of the wearable exoskeleton 102 and the passive hand 104 are co-axial as shown in FIG. 6. Beneficially, this enables the control of two degrees of freedom using a single 4-bar linkage (e.g., the first linkage system 602) that drives the flexion axis of the TM joint. Additionally, the IP joint of the thumb 130 is not parallel to the two existing axes of motion. To control this new degree of freedom, a second spatial 4-bar linkage is introduced. The coupler is connected to the first 4-bar linkage (e.g., the first linkage system 602) via two perpendicular joints in series (e.g., the serial revolute joints 616), enabling independent control of the third degree of freedom while maintaining the constraints of the initial system.

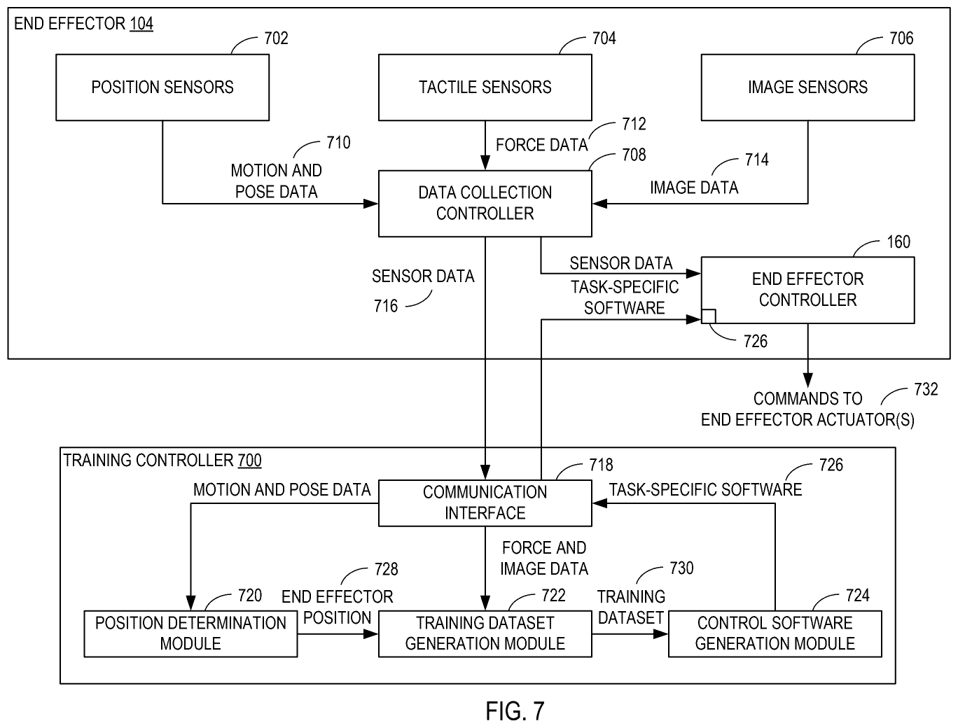

FIG. 7 shows a block diagram of an example implementation of a training controller 700 and a portion of the end effector 104 of FIGS. 1 and/or 2. The portion of the end effector 104 shown in FIG. 7 includes position sensors 702, tactile sensors 704, image sensors 706, a data collection controller 708, and the end effector controller 160 of FIG. 1.

The end effector 104 includes the position sensors 702 to determine position parameters of the end effector 104, or portion(s) thereof, such as one or more fingers. For example, the position sensors 702 can determine one or more position parameters of the thumb 116, the index finger 118, the middle finger 120 and/or, more generally, the end effector 104.

Examples of the position parameters include a pose, an acceleration, a direction, and a speed of a finger and/or, more generally, the end effector 104. For example, the position sensors 702 can be configured to sense at least one of a pose, an acceleration, a direction, or a speed of a finger and/or, more generally, the end effector 104.

Examples of the position sensors 702 include an encoder and an IMU. For example, the position sensors 702 can include one or more encoders and/or one or more IMUs. In some embodiments, the encoders have resolution of multiple bits. Examples of multi-bit encoders include 12-bit encoders and 16-bit encoders. In some embodiments, the position sensors 702 correspond to and/or implement the first sensor 136, the second sensor 138, the third sensor 140, and/or the twelfth sensor 158 of FIG. 1 and/or the encoder 202 of FIG. 2.

As shown, the position sensors 702 output first data 710 to the data collection controller 708. The first data 710 is motion and pose data. Examples of the motion data include acceleration along one or more axes, a direction along the one or more axes, and a speed along the one or more axes. Examples of the pose data include position and orientation data. The position data may include coordinates (e.g., x, y, and/or z coordinates in a 3D coordinate plane) and/or units of length (e.g., meters, feet). The position data may be represented as a vector (e.g., a 3D vector for x, y, and z coordinates). The orientation data may include units of rotation (e.g., degrees, radians). The orientation data may be represented by a quaternion, a rotation matrix, Euler angles, unit vectors, and/or axis-angle representations.

The end effector 104 includes the tactile sensors 704 to determine force parameters of the end effector 104, or portion(s) thereof, such as a force applied to contact pads of one or more fingers. For example, the tactile sensors 704 can determine one or more force parameters of the thumb 116, the index finger 118, the middle finger 120 and/or, more generally, the end effector 104.

Examples of the tactile sensors 704 include optical-tactile sensors (e.g., camera-based tactile sensors), pressure sensors, strain gauge force sensors, and capacitive force sensors, piezoelectric sensors, and load cells. For example, the tactile sensors 704 can include one or more optical-tactile sensors, such as camera-based tactile sensors. In some embodiments, the tactile sensors 704 correspond to and/or implement one(s) of the tactile sensors 142, 144, 146, 148, 150, 152, 154, 156 of FIG. 1.

As shown, the tactile sensors 704 output second data 712 to the data collection controller 708. The second data 712 is force data. Examples of the force data include a measurement of force and can be represented in Newtons (N) or pounds-force (lbf). The force data may be represented as a vector in which each element is a force measurement for one of the fingers, or portion(s) thereof.

The end effector 104 includes the image sensors 706 to capture images of the fingers 116, 118, 120 the end effector 104, an object manipulated by the end effector 104, and/or an environment including the same. The images can be color images. The image sensors 706 can include one or more image sensors configured to capture still-image(s) and/or video of the fingers 116, 118, 120 the end effector 104, an object manipulated by the end effector 104, and/or an environment including the same. Although the end effector 104 is shown in FIG. 7 to include the image sensors 706, the image sensors 706 may be separate from the end effector 104.

Examples of the image sensors 706 include complementary metal-oxide semiconductor (CMOS) image sensors, charge-coupled device (CCD) image sensors, global shutter cameras, and rolling shutter cameras. In some embodiments, the image sensors 706 correspond to and/or implement the camera(s) 162 of FIG. 1.

As shown, the image sensors 706 output third data 714 to the data collection controller 708. The third data 714 is image data. Examples of the image data include pixel data for each color (e.g., red, green, blue pixel data) and luminance data (e.g., brightness data). The image data may be compressed or uncompressed.

In some embodiments in which there are multiple image sensors 706, the signals from the multiple image sensors 706 can be collected. For example, when there are four image sensors 706, the signals can be collected using a quadrascopic camera bundle kit.

In some embodiments, the image sensors 706 include and/or implement at least one image signal processor (ISP) such that raw sensor data generated by the image sensors 706 is processed by the at least one ISP into the third data 714. In some embodiments, the image sensors 706 can output the raw sensor data to the data collection controller 708 for image signal processing.

The end effector 104 includes the data collection controller 708 to receive signals indicative of one or more parameters of the end effector 104. The signals of this example include signals representative of the first data 710, the second data 712, and/or the third data 714. The data collection controller 708 can process the signals into fourth data 716. The fourth data 716 of this example is sensor data. For example, the sensor data can include at least one of the first data 710, the second data 712, or the third data 714, or processed version(s) thereof. In such an example, the sensor data can include at least one of an acceleration, a direction, a pose, a speed, one or more images (e.g., a stream of images, video), or a force of the end effector 104, or portion(s) thereof, such as the same for one or more of the fingers 116, 118, 120 of the end effector 104.

In some embodiments, the data collection controller 708 receives the first data 710, the second data 712, and/or the third data 714 via one or more communication interfaces. Examples of the one or more communication interfaces include a serial interface, a bus, and a camera interface.

Examples of the serial interface include RS-232, RS-485, and UART. Examples of the bus include an I2C bus, a PCI bus, a PCIe bus, a SPI bus, and a UCIe bus. For example, the data collection controller 708 can receive the first data 710 via RS-485. In another example, the data collection controller 708 can receive the second data 712 via a SPI bus.

Examples of the camera interface include Universal Serial Bus (USB), Ethernet, Mobile Industry Processor Interface Camera Serial Interface Type-2 (MIPI CSI-2), a MIPI A-PHY interface, Camera Link, and CoaXPress. For example, the data collection controller 708 can receive the third data 714 via a MIPI CSI-2 interface.

In some embodiments, the data collection controller 708 is implemented by at least one programmable processor. Examples of programmable processors include CPUs, DSPs, FPGAs, GPUs, and ISPs. In some embodiments, the data collection controller 708 is implemented by one or more first programmable processors of a first type (e.g., one or more CPUs) and one or more second programmable processors of a second type (e.g., one or more ISPs), different from the first type.

As shown, the data collection controller 708 outputs the sensor data 716 to the end effector controller 160 and the training controller 700. Although the training controller 700 is shown as separate from the end effector 104, in some embodiments, the end effector 104 may include the training controller 700.

The training controller 700 of this example includes a communication interface 718, a position determination module 720, a training dataset generation module 722, and a control software generation module 724. The training controller 700 includes the communication interface 718 to receive data from and/or output data to the end effector 104. For example, the communication interface 718 can receive the fourth data 716 from the data collection controller 708 and output task-specific software 726 to the end effector controller 160.

Examples of the communication interface 718 include a serial interface, a bus, and a camera interface. For example, the communication interface 718 can communicate with the data collection controller 708 and/or the end effector controller 160 via the same type of interface, such as USB. Alternatively, the communication interface 718 may communicate with the data collection controller 708 and the end effector controller 160 using different interfaces. For example, the communication interface 718 can communicate with the data collection controller 708 via Ethernet and with the end effector controller 160 over USB.

The communication interface 718 can be configured to output portion(s) of the fourth data 716 to the position determination module 720 and the training dataset generation module 722. As shown, the communication interface 718 can output the first data 710 to the position determination module 720. As shown, the communication interface 718 can output the second data 712 and/or the third data 714 to the training dataset generation module 722.

The training controller 700 includes the position determination module 720 to determine an end effector position 728 using the first data 710. The end effector position 728 can be a position (e.g., a global position) of one(s) of the fingers 116, 118, 120 a position of the end effector 104, and/or a position of an arm that includes the same. The end effector position 728 can be represented by vector(s) and/or coordinate(s).

In some embodiments, the position determination module 720 determines the end effector position 728 by mapping position data to an end effector component (e.g., a finger, a palm, the entire end effector) and/or environment using a mapping technique (e.g., a position mapping technique). The end effector position 728 can be an estimated trajectory (e.g., a path) and/or a map of an environment including the component. Examples of the mapping technique include a Simultaneous Localization and Mapping (SLAM) technique and an IMU/SLAM technique that fuses IMU sensors with SLAM algorithms.

The training controller 700 includes the training dataset generation module 722 to generate a training dataset 730. For example, the training dataset 730 can be used to train a robotic system to perform a task, such as a dexterous manipulation task. In such an example, the training dataset 730 can be used to train a computer-implemented model, such as a machine learning (ML) model, to process the sensor data 716 into commands 732 to one or more end effector actuators.

In some embodiments, the training dataset generation module 722 generates the training dataset 730 without human involvement. For example, the training dataset generation module 722 can generate the training dataset 730 by autonomously generating labels for supervised learning types of training datasets.

In some embodiments, the training dataset generation module 722 receives input from a user (e.g., a human user) to generate the training dataset 730. For example, the training dataset generation module 722 can receive at least some labels from the user to generate supervised learning training datasets.

The training dataset 730 can include the end effector position 728, the second data 712, and/or the third data 714. For example, the training dataset 730 can include data that associates a dexterous manipulation task, such as installing a lightbulb, to the corresponding motion, pose, and/or force data undertaken by the end effector 104 to perform the dexterous manipulation task.

In some embodiments, the training dataset 730 is a supervised learning training dataset to train an ML model. Alternatively, the training dataset 730 may be an unsupervised learning training dataset to train an ML model. The supervised learning training dataset can include assignments of labels to input data and/or output data. For example, images of objects and/or environments can be labeled with their correct identifications to train the ML model to identify the same or similar objects in an environment of the end effector 104. The supervised learning training dataset can include labels used to define desired states or actions while performing a task. For example, the labels can include a desired acceleration, direction, pose, speed, and/or force of a portion of the end effector 104 while the end effector 104 is performing one or more stages of a dexterous manipulation task.

In some embodiments, as discussed above, the computer-implemented model is an ML model. The ML model can be a deep learning model. Examples of a deep learning model include a neural network. Examples of a neural network include an autoencoder, a convolutional neural network (CNN), a CTC-fitted neural network model, a graph neural network (GNN), a multi-layer perceptron, a recurrent neural network (RNN), a generative adversarial network (GAN), and a transformer. Alternatively, the computer-implemented model may be and/or be implemented by a different type of machine learning model, such as a clustering model, a decision tree, a support vector machine (SVM), a Bayesian network, a hidden Markov model, and/or any combination(s) thereof.

The training controller 700 includes the control software generation module 724 to generate and/or train at least one computer-implemented model in accordance with the training dataset 730. The control software generation module 724 can train the at least one computer-implemented model to operate a robotic system, or portion(s) thereof such as the end effector 104. The at least one computer-implemented model can be at least one ML model.

As shown, the control software generation module 724 can output the at least one computer-implemented model as the task-specific software 726. In some embodiments, the task-specific software 726 is implemented by machine-readable instructions (e.g., processor-executable instructions). The machine-readable instructions can be implemented as an executable (e.g., an executable file).

In some embodiments, the task-specific software 726 is implemented using an ML model format. Examples of the ML model format include. pb, .h5, and .tflite formats for TensorFlow and Keras based implementations. Further examples of the ML model format include .pt or .pth for PyTorch based implementations. Additional examples of the ML model format include .onnx for the Open Neural Network Exchange, .safetensors for Safetensors, and .pkl for Pickle.

As shown, the control software generation module 724 outputs the task-specific software 726 to the end effector controller 160 via the communication interface 718. As shown, the end effector controller 160 can receive the task-specific software 726 and store the task-specific software 726 in memory and/or mass storage of the end effector controller 160.

In example operation, the end effector 104 can perform one or more stages of a dexterous manipulation task. During the one or more stages, the end effector controller 160 can receive the fourth data 716 corresponding to interactions of the end effector 104 with an object and/or an environment including the object during the one or more stages. The fourth data 716 can be a stream of the global position, hand joint angle(s), force measurements, tactile images, in-hand camera images, and/or global images in substantially real time (e.g., within 1 ms, 5 ms, 10 ms, 50 ms, 100 ms, etc., of real time). The end effector controller 160 can process the fourth data 716 using the task-specific software 726 to generate the commands 732 to control one or more of the fingers 116, 118, 120 and/or, more generally, the end effector 104, during the one or more stages. Examples of the commands 732 include moving a finger, manipulating (e.g., grasping, holding, grabbing, moving) an object with the end effector 104, and manipulating a tool (e.g., a drill, a screwdriver) to be applied to the object.

By way of example, the end effector 104 can be deployed to perform a dexterous manipulation task such as drilling. To perform the drilling task, the end effector 104 is to pick up a drill, insert the drill bit of the drill into a fastener, and tighten the fastener into an object by actuating the drill. Example stages include grasping a drill, aligning the drill to a fastener (e.g., a screw), and actuating the drill to install the fastener into an object. In this example, during the stages, the sensors 702, 704, 706 generate and output the first data 710, the second data 712, and the third data 714 to the data collection controller 708. The data collection controller 708 processes the received data into the fourth data 716 for output to the end effector controller 160. The end effector controller 160 executes the task-specific software 726 by processing the fourth data 716 into the commands 732. More particularly, the end effector controller 160 receives the fourth data 716 corresponding to the stage in which the end effector 104 aligns the drill to the fastener and processes the fourth data 716 using the task-specific software 726 to determine motion and pose parameters, force parameters, etc., to complete the next stage of actuating the drill. The end effector controller 160 can generate the commands 732 based on the determined parameters. For example, the end effector controller 160 can output the commands 732 to the index finger 118 to press the button on the drill (to actuate the drill) in accordance with at least the determined force parameter to do so.

By way of another example, the end effector 104 can be deployed to perform a dexterous manipulation task such as box packaging. To perform the packaging task, the end effector 104 is to fold one flap of a box, fold another flap of the box, fold a large flap of the box, insert an edge into a slot of the box, and press down to secure the box. In this example, the sensors 702, 704, 706 generate and output the first data 710, the second data 712, and the third data 714 to the data collection controller 708. The data collection controller 708 processes the received data into the fourth data 716 for output to the end effector controller 160. The end effector controller 160 executes the task-specific software 726 by processing the fourth data 716 into the commands 732. More particularly, the end effector controller 160 receives the fourth data 716 corresponding to the stage in which the end effector 104 is folding a first flap of the box and processes the fourth data 716 using the task-specific software 726 to determine motion and pose parameters, force parameters, etc., to complete the next stage of box packaging. The end effector controller 160 can generate the commands 732 based on the determined parameters. For example, the end effector controller 160 can output the commands 732 to the fingers 116, 118, 120 to grasp and fold the flap in accordance with at least the determined motion, pose, and force parameters to do so.

By way of yet another example, the end effector 104 can be deployed to perform a dexterous manipulation task such as bottle opening. To perform the bottle opening task, the end effector 104 is to hold the bottle, move the thumb 116 to the bottle lid, and swing the thumb 116 to open the bottle. In this example, the sensors 702, 704, 706 generate and output the first data 710, the second data 712, and the third data 714 to the data collection controller 708. The data collection controller 708 processes the received data into the fourth data 716 for output to the end effector controller 160. The end effector controller 160 executes the task-specific software 726 by processing the fourth data 716 into the commands 732. More particularly, the end effector controller 160 receives the fourth data 716 corresponding to the stage in which the end effector 104 is holding the bottle and processes the fourth data 716 using the task-specific software 726 to determine motion and pose parameters, force parameters, etc., to identify and grasp the bottle. The end effector controller 160 can generate the commands 732 based on the determined parameters. For example, the end effector controller 160 can output the commands 732 to the fingers 116, 118, 120 to move towards the bottle and grasp it in accordance with at least the determined motion, pose, and force parameters as determined by the task-specific software 726 in order to do so.

By way of another example, the end effector 104 can be deployed to perform a dexterous manipulation task such as light bulb installation. To perform the light bulb installation task, the end effector 104 is to grasp the light bulb, put into a light bulb holder, rotate the light bulb to install, grasp a lamp shade, and place the lamp shade over the light bulb. In this example, the sensors 702, 704, 706 generate and output the first data 710, the second data 712, and the third data 714 to the data collection controller 708. The data collection controller 708 processes the received data into the fourth data 716 for output to the end effector controller 160. The end effector controller 160 executes the task-specific software 726 by processing the fourth data 716 into the commands 732. More particularly, the end effector controller 160 receives the fourth data 716 corresponding to the stage in which the end effector 104 is rotating the light bulb and processes the fourth data 716 using the task-specific software 726 to determine motion and pose parameters, force parameters, etc., to rotate the light bulb a number of times for proper installation into the light bulb holder. The end effector controller 160 can generate the commands 732 based on the determined parameters. For example, the end effector controller 160 can output the commands 732 to the fingers 116, 118, 120 to grasp the light bulb and rotate it a determined number of times in accordance with at least the determined motion, pose, and force parameters as determined by the task-specific software 726 in order to do so.

While an example implementation of the end effector 104 of FIG. 1 is depicted in FIG. 7, other implementations are contemplated. Further, other implementations for the training controller 700 are contemplated. For example, one or more blocks, components, functions, etc., of the end effector 104 and/or the training controller 700 may be combined or divided in any other way. The end effector 104 and/or the training controller 700 of the illustrated example may be implemented by hardware alone, or by a combination of hardware, software, and/or firmware. For example, the end effector 104 and/or the training controller 700 may be implemented by one or more analog or digital circuits (e.g., comparators, operational amplifiers, etc.), one or more hardware-implemented state machines, one or more programmable processors, one or more network interfaces (e.g., network interface circuitry, network interface cards (NICs), smart NICs, etc.), one or more application specific integrated circuits (ASICs), one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof.

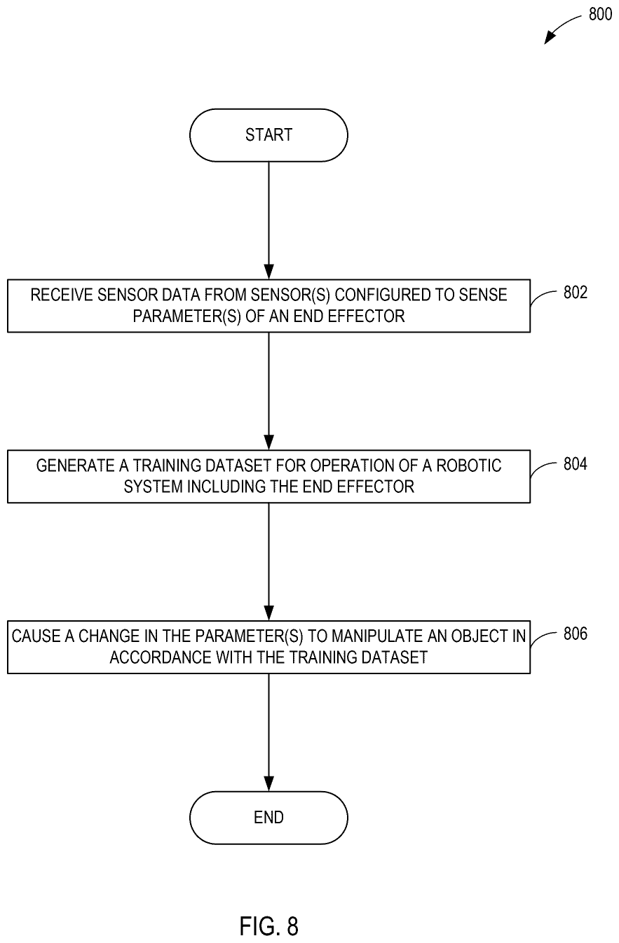

FIG. 8 is a flowchart 800 representative of an example process to be performed and/or example machine-readable instructions that may be executed by processor circuitry to implement the training controller 700 of FIG. 7 to cause a change in parameter(s) of the end effector 104 of FIGS. 1 and/or 2 to manipulate an object in accordance with a training dataset. Additionally or alternatively, the flowchart 800 may be implemented by the end effector 104 (e.g., the end effector controller 160) and/or, more generally, the robotic training system 100 of FIG. 1. Additionally or alternatively, block(s) of one(s) of the flowchart 800 of FIG. 8 may be representative of state(s) of one or more hardware-implemented state machines, algorithm(s) that may be implemented by hardware alone such as an ASIC, etc., and/or any combination(s) thereof.

The flowchart 800 of FIG. 8 begins at block 802, at which the training controller 700 may receive sensor data from sensor(s) configured to sense parameter(s) of an end effector. The end effector can be a limb, such as a hand, arm, leg, or foot. The end effector can be the end effector 104 of FIGS. 1 and/or 2. For example, the communication interface 718 of FIG. 7 can receive the fourth data 716 from data collection controller 708. In such an example, the communication interface 718 can receive at least one of the first data 710, the second data 712, or the third data 714 generated by at least one of the position sensors 702, the tactile sensors 704, or the image sensors 706.

At block 804, the training controller 700 may generate a training dataset for operation of a robotic system including the end effector. For example, the training dataset generation module 722 can generate the training dataset 730 using at least one of the end effector position 728, the second data 712, or the third data 714.

At block 806, the training controller 700 may cause a change in the parameter(s) to manipulate an object in accordance with the training dataset. For example, the control software generation module 724 can train an ML model using the training dataset 730. The control software generation module 724 can output the trained ML model as the task-specific software 726 to the end effector controller 160. The end effector controller 160 can receive streaming sensor data, such as the fourth data 716, while the end effector 104 is performing an aspect of a dexterous manipulation task. The end effector controller 160 can execute the task-specific software 726 using the streaming sensor data as input to generate the commands 732 as output. The end effector controller 160 can output the commands 732 to control one or more actuators of an end effector to change parameter(s) (e.g., acceleration, pose, force, etc.) of the end effector. For example, the commands 732 can be electrical signals to one(s) of the actuators 330, 332 of FIG. 3B of one(s) of the fingers 116, 118, 120 to move the one(s) of the fingers 116, 118, 120 to carry out the aspect of the dexterous manipulation task. After causing the change in the parameter(s) to manipulate an object in accordance with the training dataset at block 806, the flowchart 800 of FIG. 8 concludes. Alternatively, the flowchart 800 may be executed again after block 806 is complete, such that the flowchart 800 is iteratively executed until the dexterous manipulation task is complete.

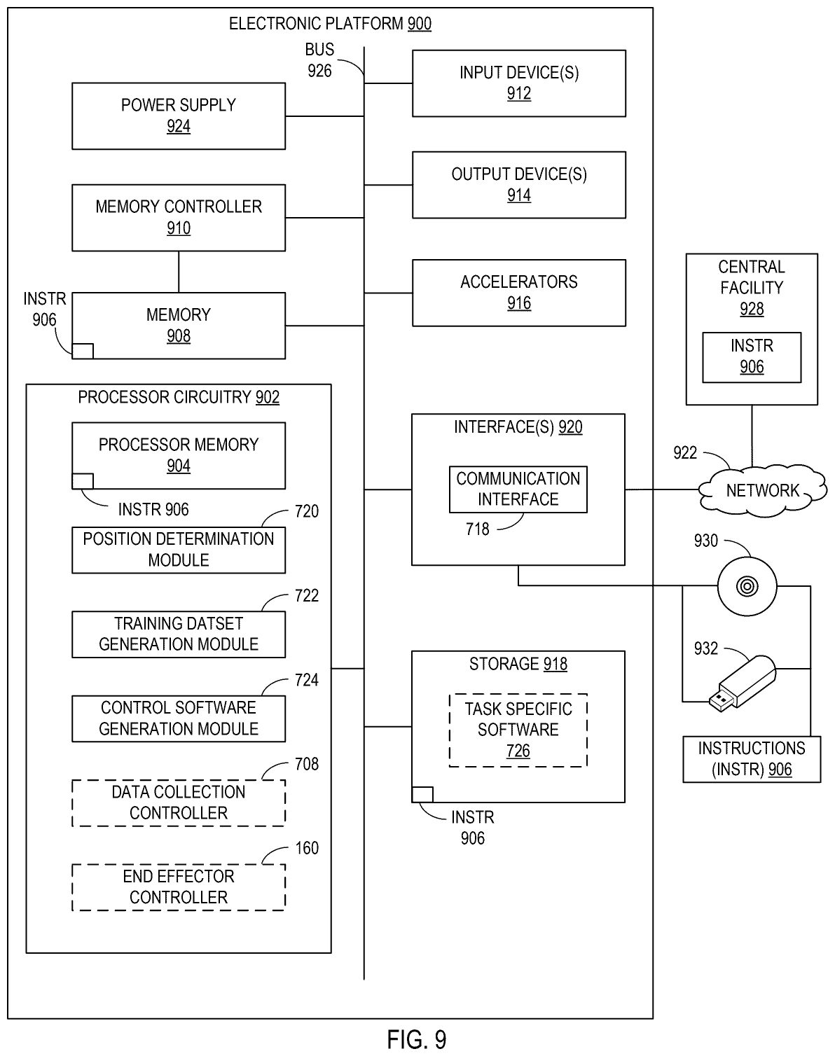

FIG. 9 is an example implementation of an electronic platform 900 structured to execute the machine-readable instructions of FIG. 8 to implement the training controller 700 of FIG. 7. Additionally, in some embodiments, the electronic platform 900 can be structured to implement the end effector 104 of FIGS. 1 and/or 2, or portion(s) thereof. It should be appreciated that FIG. 9 is intended neither to be a description of necessary components for an electronic and/or computing device to operate as portion(s) of an end effector and/or a training controller, in accordance with the techniques described herein, nor a comprehensive depiction.

The electronic platform 900 of this example may be an electronic device, such as a handset device (e.g., a cellular network device, a smartphone, etc.), a desktop computer, a laptop computer, a tablet computer, a server (e.g., a computer server, a blade server, a rack-mounted server, etc.), a wearable device (e.g., an augmented reality and/or virtual reality (AR/VR) device, a heads-up display (HUD) device, etc.), a workstation, or any other type of computing and/or electronic device. In some embodiments, the electronic platform 900 may be a robot, or portion(s) thereof, such as an end effector (e.g., a hand, a robotic hand).

The electronic platform 900 of the illustrated example includes processor circuitry 902, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 902 includes processor memory 904, which may be volatile memory, such as random-access memory (RAM) of any type. The processor circuitry 902 of this example implements the position determination module 720, the training dataset generation module 722, the control software generation module 724 and/or, more generally, the training controller 700 of FIG. 7. Additionally and/or alternatively, the processor circuitry 902 may implement the data collection controller 708 of FIG. 7 and/or the end effector controller 160 of FIGS. 1 and/or 7.

The processor circuitry 902 may execute machine-readable instructions 906 (identified by INSTRUCTIONS), which are stored in the processor memory 904, to implement at least one of the position determination module 720, the training dataset generation module 722, the control software generation module 724, the data collection controller 708, or the end effector controller 160. The machine-readable instructions 906 may include data representative of computer-executable and/or machine-executable instructions implementing techniques that operate according to the techniques described herein. For example, the machine-readable instructions 906 may include data (e.g., code, embedded software (e.g., firmware), software, etc.) representative of the flowchart 800 of FIG. 8, or portion(s) thereof.

The electronic platform 900 includes memory 908, which may include the instructions 906. The memory 908 of this example may be controlled by a memory controller 910. For example, the memory controller 910 may control reads, writes, and/or, more generally, access(es) to the memory 908 by other component(s) of the electronic platform 900. The memory 908 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 900 includes input device(s) 912 to enable data and/or commands to be entered into the processor circuitry 902. For example, the input device(s) 912 may include an audio sensor, a camera (e.g., a still camera, a video camera, etc.), a keyboard, a microphone, a mouse, a touchscreen, a voice recognition system, etc., and/or any combination(s) thereof.

The electronic platform 900 includes output device(s) 914 to convey, display, and/or present information to a user (e.g., a human user, a machine user, etc.). For example, the output device(s) 914 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 914 can be used, among other things, to generate, launch, and/or present a user interface. For example, the user interface may be generated and/or implemented by the output device(s) 914 for visual presentation of output and speakers or other sound generating devices for audible presentation of output.

The electronic platform 900 includes accelerators 916, which are hardware devices to which the processor circuitry 902 may offload compute tasks to accelerate their processing. For example, the accelerators 916 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some embodiments, one or more of the position determination module 720, the training dataset generation module 722, the control software generation module 724, the data collection controller 708, and/or the end effector controller 160 may be implemented by one(s) of the accelerators 916 instead of the processor circuitry 902. In some embodiments, the position determination module 720, the training dataset generation module 722, the control software generation module 724, the data collection controller 708, and/or the end effector controller 160 may be executed concurrently (e.g., in parallel, substantially in parallel, etc.) by the processor circuitry 902 and the accelerators 916. For example, the processor circuitry 902 and one(s) of the accelerators 916 may execute in parallel function(s) corresponding to the training dataset generation module 722.

The electronic platform 900 includes storage 918 to record and/or control access to data, such as the machine-readable instructions 906. In some embodiments, the storage 918 stores the task-specific software 726. The storage 918 may be implemented by one or more mass storage disks or devices, such as HDDs, SSDs, etc., and/or any combination(s) thereof.

The electronic platform 900 includes interface(s) 920 to effectuate exchange of data with external devices (e.g., computing and/or electronic devices of any kind) via a network 922. In this example, the interface(s) 920 implement(s) the communication interface 718 of FIG. 7.

The interface(s) 920 of the illustrated example may be implemented by an interface device, such as network interface circuitry (e.g., a NIC, a smart NIC, etc.), a gateway, a router, a switch, etc., and/or any combination(s) thereof. The interface(s) 920 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-CTM or USB-CTM, etc.), etc., and/or any combination(s) thereof.

The electronic platform 900 includes a power supply 924 to store energy and provide power to components of the electronic platform 900. The power supply 924 may be implemented by a power converter, such as an alternating current-to-direct-current (AC/DC) power converter, a direct current-to-direct current (DC/DC) power converter, etc., and/or any combination(s) thereof. For example, the power supply 924 may be powered by an external power source, such as an alternating current (AC) power source (e.g., an electrical grid), a direct current (DC) power source (e.g., a battery, a battery backup system, etc.), etc., and the power supply 924 may convert the AC input or the DC input into a suitable voltage for use by the electronic platform 900. In some examples, the power supply 924 may be a limited duration power source, such as a battery (e.g., a rechargeable battery such as a lithium-ion battery).

Component(s) of the electronic platform 900 may be in communication with one(s) of each other via a bus 926. For example, the bus 926 may be any type of computing and/or electrical bus, such as an I2C bus, a PCI bus, a PCIe bus, a SPI bus, a UCIe bus, and/or the like. Additionally and/or alternatively, component(s) of the electronic platform 900 may be in communication with one(s) of each other via a serial interface and/or camera interface.

The network 922 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 922 may be the Internet, but any other type of private and/or public network is contemplated.

The network 922 of the illustrated example facilitates communication between the interface(s) 920 and a central facility 928. The central facility 928 in this example may be an entity associated with one or more servers, such as one or more physical hardware servers and/or virtualizations of the one or more physical hardware servers. For example, the central facility 928 may be implemented by a public cloud provider, a private cloud provider, etc., and/or any combination(s) thereof. In this example, the central facility 928 may compile, generate, update, etc., the machine-readable instructions 906 and store the machine-readable instructions 906 for access (e.g., download) via the network 922. For example, the electronic platform 900 may transmit a request, via the interface(s) 920, to the central facility 928 for the machine-readable instructions 906 and receive the machine-readable instructions 906 from the central facility 928 via the network 922 in response to the request.

Additionally or alternatively, the interface(s) 920 may receive the machine-readable instructions 906 via non-transitory machine-readable storage media, such as an optical disc 930 (e.g., a Blu-ray disc, a CD, a DVD, etc.) or any other type of removable non-transitory machine-readable storage media such as a USB drive 932. For example, the optical disc 930 and/or the USB drive 932 may store the machine-readable instructions 906 thereon and provide the machine-readable instructions 906 to the electronic platform 900 via the interface(s) 920.

Techniques operating according to the principles described herein may be implemented in any suitable manner. The processing and decision blocks of the flowchart(s) above represent steps and acts that may be included in algorithms that carry out these various processes. Algorithms derived from these process(es) may be implemented as software integrated with and directing the operation of one or more single-or multi-purpose processors, may be implemented as functionally equivalent circuits such as a DSP circuit or an ASIC, or may be implemented in any other suitable manner. It should be appreciated that the flowchart(s) included herein do(es) not depict the syntax or operation of any particular circuit or of any particular programming language or type of programming language. Rather, the flowchart(s) illustrate the functional information one skilled in the art may use to fabricate circuits or to implement computer software algorithms to perform the processing of a particular apparatus carrying out the types of techniques described herein. For example, the flowchart(s), or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In another example, the flowchart(s), or portion(s) thereof, may be implemented by machine-executable instructions (e.g., machine-readable instructions, computer-readable instructions, computer-executable instructions, etc.) that, when executed by one or more single-or multi-purpose processors, carry out the various process(es) of the flowchart(s). It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.).

Machine-executable instructions (e.g., processor-executable instructions) implementing the techniques described may, in some embodiments, be encoded on one or more computer-readable media, machine-readable media, etc., to provide functionality to the media. Computer-readable media, machine-readable media, etc., include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium, a machine-readable medium, etc., may be implemented in any suitable manner.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way.

Accordingly, embodiments may be constructed in which acts are performed in an order different than illustrated, which may include performing some acts simultaneously, even though shown as sequential acts in illustrative embodiments.

As used herein, the terms “computer-readable media” (also called “computer-readable storage media”), “computer-readable medium” (also called “computer-readable storage medium”), “machine-readable media” (also called “machine-readable storage media”), and “machine-readable medium” (also called “machine-readable storage medium”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques-such as implementations where the techniques are implemented as machine-executable instructions-the information may be encoded on a computer-readable storage medium, a machine-readable storage medium, etc. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.” As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A,, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Accordingly, having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. An apparatus for training a robotic system comprising:
an end effector configured to manipulate an object;
a passive exoskeleton configured to be manipulated by a portion of a user's body to change one or more parameters of the end effector;
one or more linkages coupling the end effector to the passive exoskeleton, wherein the one or more linkages transmit forces applied to the end effector, due to interactions of the end effector with a surrounding environment comprising the object, to the portion of the user's body through the passive exoskeleton; and
one or more sensors coupled to the end effector and configured to:
sense the one or more parameters of the end effector; and
output one or more signals indicative of the one or more parameters.

2. The apparatus of claim 1, further comprising one or more hardware processors configured to:
receive the one or more signals indicative of the one or more parameters; and
generate a training dataset for operation of the robotic system using the one or more parameters of the end effector.

3. The apparatus of claim 2, wherein the end effector comprises one or more actuators operatively coupled to the end effector and configured to change the one or more parameters of the end effector in accordance with the training dataset.

4. The apparatus of claim 1, wherein the end effector comprises a plurality of fingers configured to manipulate the object.

5. The apparatus of claim 1, wherein the one or more linkages are one or more rigid linkages.

6. The apparatus of claim 1, wherein the one or more parameters of the end effector comprise at least one of an acceleration, a direction, a pose, or a speed of a portion of the end effector, and the one or more sensors are configured to sense the at least one of the acceleration, the direction, the pose, or the speed of the portion of the end effector.

7. The apparatus of claim 6, wherein the one or more sensors coupled to the end effector comprise one or more encoders and/or one or more inertial measurement units coupled to the end effector, and the one or more encoders and/or the one or more inertial measurement units is/are configured to:
sense the at least one of the acceleration, the direction, the pose, or the speed of the portion of the end effector; and
output the one or more signals indicative of the at least one of the acceleration, the direction, the pose, or the speed of the portion of the end effector.

8. The apparatus of claim 1, further comprising:
a limb connected to the end effector; and
one or more second sensors coupled to the limb and configured to:
sense one or more second parameters of the limb; and
output one or more second signals indicative of the one or more second parameters.

9. The apparatus of claim 1, wherein the one or more parameters comprise a force applied by a portion of the end effector to the object, the one or more sensors coupled to the end effector comprise one or more tactile sensors disposed on one or more contact pads of the end effector, and the one or more tactile sensors are configured to:
sense the force applied by the portion of the end effector to the object; and
output the one or more signals indicative of at least the sensed force.

10. The apparatus of claim 1, further comprising one or more image sensors configured to:
capture a stream of images of at least one of the end effector, the object, or the surrounding environment during manipulation of the object; and
output the stream of images.

11. The apparatus of claim 1, wherein the passive exoskeleton does not comprise an actuator.

12. A method for training a robotic system comprising:
manually manipulating, using a passive exoskeleton, one or more parameters of an end effector to manipulate an object;
transmitting, using one or more linkages of the passive exoskeleton, forces applied to the end effector to a portion of a user's body due to interactions of the end effector with a surrounding environment; and
sensing, using one or more sensors, one or more parameters of the end effector while facilitating manipulation of the object to generate a training dataset for operation of the robotic system.

13. The method of claim 12, further comprising:
receiving, using at least one communication interface, one or more signals indicative of the one or more parameters of the end effector; and
generating, using one or more hardware processors and the one or more parameters, the training dataset for operation of the robotic system.

14. The method of claim 13, further comprising:
generating, using the one or more hardware processors and the training dataset, machine readable instructions for operation of the robotic system in accordance with the training dataset; and
outputting, using the at least one communication interface, the machine readable instructions to the robotic system for operation of the robotic system.

15. The method of claim 12, further comprising operating the robotic system in accordance with the training dataset and using the one or more parameters during manipulation of the object or a different object.

16. The method of claim 12, further comprising:
capturing, using at least one image sensor, a stream of images of at least one of the end effector, the object, or the surrounding environment during manipulation of the object; and
generating, using one or more hardware processors and the stream of images, the training dataset for operation of the robotic system.

17. At least one computer-readable storage medium storing processor executable instructions that, when executed by at least one hardware processor, cause the at least one hardware processor to:
receive, using at least one communication interface, sensor data from one or more sensors configured to sense one or more parameters of an end effector when the end effector is manually manipulated by a passive exoskeleton to manipulate an object;
generate, using the sensor data, a training dataset for operation of a robotic system comprising the end effector; and
cause a change in the one or more parameters of the end effector to manipulate the object in accordance with the training dataset.

18. The at least one computer-readable storage medium of claim 17, wherein the processor executable instructions cause the at least one hardware processor to:
receive one or more signals indicative of the one or more parameters of the end effector; and
generate, using the one or more parameters, a training dataset for operation of the robotic system.

19. The at least one computer-readable storage medium of claim 18, wherein the processor executable instructions are first processor executable instructions and cause the at least one hardware processor to:
generate second processor executable instructions for operation of the robotic system in accordance with the training dataset; and
output the second processor executable instructions to the robotic system for operation of the robotic system.

20. The at least one computer-readable storage medium of claim 17, wherein the one or more parameters comprise at least one of motion data, pose data, or force data associated with the end effector, and the processor executable instructions cause the at least one hardware processor to:
receive, from at least one image sensor, a stream of images of at least one of the end effector, the object, or an environment during manipulation of the object; and
generate, using the at least one of the motion data, the pose data, the force data, or the stream of images, the training dataset for operation of the robotic system.
